(19) United States
(12) Patent Application Publication
(10) Pub. No.: US 2020/0056566 A1
(43) Pub. Date: Feb. 20, 2020

(54) Method and Device for Increasing the Global Compression Ratio of an Internal Combustion Engine in the Case of Varying Fuel Quality

(71) Applicant: Bayerische Motoren Werke Aktiengesellschaft, Muenchen (DE)

(72) Inventor: Martin SCHENK, Rosenheim (DE)

(21) Appl. No.: 16/661,451

(22) Filed: Oct. 23, 2019

Related U.S. Application Data
(63) Continuation of application No. PCT/EP2018/064810, filed on Jun. 6, 2018.

(30) Foreign Application Priority Data
Jul. 19, 2017 (DE) 10 2017 212 306.0

(51) Int. Cl. F02M 25/022; F02D 41/00; F02D 19/12; F02M 25/03

(52) U.S. Cl. CPC F02M 25/0227; F02M 25/0222; F02M 25/0228; F02D 41/0025; F02D 2200/0418; F02M 25/03; F02D 2200/0611; F02D 2200/0414; F02D 19/12

(57) ABSTRACT

A method and device are provided for increasing the possible compression ratio of internal combustion engines of motor vehicles in the case of varying fuel quality in an internal combustion engine having a combustion chamber for burning the fuel. The device has an apparatus for determining the knock resistance property of the fuel, an apparatus for sensing the operating state of the internal combustion engine, a water tank, and a feeding apparatus for the water. In the method, the knock resistance property of the fuel is determined and the operating state of the internal combustion engine is sensed. A need for a feed of water to the fuel is determined therefrom.

### CROSS REFERENCE TO RELATED APPLICATIONS

This application is a continuation of PCT International Application No. PCT/EP2018/064810, filed Jun. 6, 2018, which claims priority under 35 U.S.C. § 119 from German Patent Application No. 10 2017 212 306.0, filed Jul. 19, 2017, the entire disclosures of which are herein expressly incorporated by reference.

### BACKGROUND AND SUMMARY OF THE INVENTION

The invention relates to a method and to a device for increasing the global compression ratio of an internal combustion engine of a motor vehicle in the case of varying fuel quality in an engine having a combustion chamber for burning the fuel. The invention also relates to a control apparatus for carrying out the method for increasing the global compression ratio of an internal combustion engine of a motor vehicle in the case of varying fuel quality and for operating the device.

The possible global compression ratio of internal combustion engines of motor vehicles in the case of varying fuel quality is decisively limited by the fuel quality and, in particular, by the knock resistance of the worst fuel which is present and is possible in the service life of the engine. Since premature auto-ignition (knocking) of the fuel/air mixture in the still unburnt mixture range (tail gas) in the combustion chamber can cause damage to the engine, to the point that it completely fails, the maximum compression of an engine is determined by the lowest quality (low octane number) fuel (a fuel with which knocking is most likely). In addition, even in the case of a relatively high intake air temperature the risk of premature ignition of the fuel/air mixture also increases. These factors limit the possible compression ratio of an internal combustion engine, even though significantly higher compression ratios, and therefore higher efficiency levels of the internal combustion engines would be possible in countries in which a high fuel quality is available and, in addition, mainly low external temperatures are present.

In particular, the relationships described above have an effect in alcohol flex fuel engines or vehicles with alcohol flex fuel engines. Such vehicles are usually operated with gasoline, the alcohols methanol or ethanol and any desired mixtures of these two, if appropriate also of all three fuels, and they have a variable fuel supply system which supplies the internal combustion engine in accordance with refueling and the variant in that country with mixtures of pure gasoline (alcohol-containing basic fuel, e.g. E24) and fuels of a higher alcohol content (e.g. E70, E85, E100). In such vehicles, the current fuel quality or the alcohol content is detected, for example, using sensors or a software solution, and the engine application and the injection duration are correspondingly selected. The possible mechanical compression ratio of the engine is selected here according to the requirements of the fuel which is most sensitive with respect to knocking and the hottest ambient conditions which occur, even though in the case of high alcohol contents (high knock resistance) it would be possible to select relatively high compression ratios. In German laid-open publication DE 10 2007 019 992 A1 or European Patent EP 1 304 466 B1 methods for analyzing fuel in such engines are described.

Short-chain alcohols such as methanol and ethanol are a very much higher quality fuel which is, in particular, very resistant to knocking. This is, on the one hand, because of the high evaporation enthalpy, and on the other hand because of the relatively low combustion temperatures owing to the intramolecular water which is already present, as well as the high lamina burning rate. In flex fuel concepts, the compression of the internal combustion engine is configured for that fuel which has the lowest knock resistance of the possible mixture spectrum. However, since the compression is an essential parameter for increasing the efficiency level of an internal combustion engine, this greatly limits the maximum possible efficiency level.

Taking this as a starting point, the invention is based on the object of providing an improved method and a correspondingly improved device for increasing the global compression ratio of the internal combustion engine of a motor vehicle in the case of varying fuel quality, and a control apparatus for carrying out the method and for operating the device.

In order to achieve the object, a method is provided for increasing the possible compression ratio of internal combustion engines for motor vehicles in the case of varying fuel quality in an internal combustion engine having a combustion chamber for burning the fuel, having an apparatus for determining the knock resistance/quality of the fuel, and having an apparatus for sensing the operating state of the internal combustion engine, a water tank and a feed apparatus for feeding the water to the fuel. The method has the following method steps:

determining the knock resistance of the fuel and/or the fuel quality;

sensing the operating state of the internal combustion engine;

determining a requirement to feed water to the fuel or to the combustion chamber in accordance with the determined knock resistance/quality of the fuel and of the operating state of the internal combustion engine; and

feeding water to the fuel or to the combustion chamber according to the determined requirement.

The feeding of water to the fuel, which occurs, in particular, by feeding water to the combustion chamber or into the air supply pipe is carried out in the method in each case in accordance with the respective requirement which is determined on the basis of the fuel which is present and operating conditions of the internal combustion engine. Therefore, the more water which is fed, the lower the knock resistance of the fuel and the more the current operating conditions of the engine favor premature self-ignition.

The feeding of water to the fuel, in particular to the combustion chamber or to the air supply pipe according to the determined requirement as a knock inhibitor to the fuel causes the mixture temperature to drop through evaporation cooling, and therefore brings about an increase in the knock resistance. In addition, the feeding of water brings about additionally improved knock protection owing to dilution effects by the water or water vapor as an inert gas. Feeding water to the fuel and therefore the associated increase in the knock resistance can, on the one hand, raise the general compression ratio and therefore the thermal efficiency of the engine and, on the other hand, as a result, with a given compression ratio, operate the engine with center of gravity positions which are significantly more favorable in terms of efficiency in the region of the engine characteristic diagram which has limited knocking. This permits a significant improvement in the fuel consumption at moderate cost and with moderate deployment of material.

The fuel which is fed to the internal combustion engine of the motor vehicle can be a mineral oil such as a gasoline, an alcohol such as ethanol or methanol, a synthetic fuel or even any desired mixture of suitable types of fuel which are compressed as a fuel/air mixture in a combustion chamber of an internal combustion engine of a motor vehicle before ignition. Gaseous fuels (LPG/CNG) can also be included.

By means of the apparatus for determining the knock resistance of the fuel, the knock resistance of the fuel which is currently contained in the fuel tank of the vehicle or of the fuel which is fed to the internal combustion engine is determined in order to determine a requirement in order to prevent early self-ignition during the compression or combustion in the combustion chamber.

Since the inclination to early self-ignition during the compression or combustion is also influenced by the respective current operating state of the engine, such as, for example, by the current engine load and rotation speed or also by the current rate of recirculation of exhaust gas, the temperature of the engine and the like, the operating state of the internal combustion engine, i.e. the current operating characteristic values, is also additionally sensed and taken into account in the determination of the requirement for feeding of water to the fuel.

In this way, a current requirement for feeding of water to the fuel is determined at least from the parameters specified above, and the water corresponding to this requirement is fed to the fuel in a corresponding time. In this relationship it is to be noted in relation to the invention that the use of the term “feeding of water” is also to be understood as meaning the metering of the respective requirement of water, in particular in conjunction with the time sequence of the feeding (duration, volume flow rate etc.)

The water which is necessary to carry out the method is stored in a water tank, connected to the feed apparatus for the water, in the motor vehicle, which water tank holds a sufficient quantity of water and can, in particular, be refilled. Additionally or alternatively, the water can also be extracted from the condensation of the ambient air such as an air-conditioning system or by condensation from the exhaust gas. The latter is very efficient, in particular in the case of alcohol fuels, owing to the high water content.

With the proposed method it is possible to use water as a knock inhibitor selectively and in accordance with requirements. This permits the consumption of water to be limited to a necessary amount, and therefore permits a large operating range of a water supply.

In one embodiment of the method for increasing the possible consumption ratio of internal combustion engines, the knock resistance of the fuel is determined by means of a sensor which is arranged, in particular, at the fuel supply system, and which senses, for example, the alcohol content in the fuel. Such sensors sense, for example, the electrical conductivity or capacitance of a fuel, from which it is possible to determine the knock resistance of a fuel, for example owing to a sensed alcohol content in the fuel. The measure for the knock resistance which is ultimately used is frequently also determined from the values acquired by a knock resistance sensor, by means by software-based evaluation, wherein additional data can also be included in such an evaluation. As a result, by using such sensors it is possible to determine with sufficient accuracy the knock resistance of the fuel which is contained in the fuel supply system, in order to determine the requirement of water for feeding to the fuel, in particular into the combustion chamber or the air supply pipe, in order to sufficiently reduce knocking phenomena during the combustion of the fuel in the combustion chamber of the engine.

In another embodiment of the method for increasing the combustion capability of a fuel, the determination of the knock resistance of the fuel is carried out in a software-based fashion using operating values of the internal combustion engine which are determined at the internal combustion engine. Various methods are known for this. In one known procedure, a determination process is carried out, for example, after a refueling operation. A refueling operation which has taken place is detected here, for example, by means of the change in the filling level in the motor vehicle tank. In such methods, the knock resistance of the fuel which is present is determined on the basis of the combustion which subsequently takes place. In this context, for example, the signals from sensors which are connected to the internal combustion engine are used, such as, for example, the signal profile of the lambda signal of an exhaust gas probe, the signal of a knock sensor or an unsmooth running sensor or a pressure sensor which senses the combustion pressure in a cylinder. Therefore, e.g. the alcohol content and therefore deductively the knock resistance of the fuel can also be determined with sufficient precision by means of software-based evaluation of, in particular, signals which are present in an engine controller, in order to determine the requirement to feed fuel to the water, without additional sensors being necessary on the motor vehicle.

One embodiment for the method for increasing the possible compression ratio of internal combustion engines in the case of varying fuel quality according to one of the preceding claims contains the further step of:

sensing the temperature of the intake air and taking into account this temperature during the determination of the requirement to feed water to fuel.

As the temperature of intake air rises, the tendency of the fuel/air mixture to knock during compression increases. By taking into account the intake air temperature it is possible to determine with greater accuracy the risk of knocking and therefore the respective requirement to feed water.

An embodiment of the method for increasing the possible compression ratio of internal combustion engines in the case of varying fuel quality according to one of the preceding claims contains the further step of:

sensing the water content of the intake air and taking into account the water content during the determination of the requirement to feed water to the fuel.

An increasing water content of the intake air reduces the tendency of the fuel/air mixture to knock during compression, since the water which is already present in the intake air acts, as already described, as a knock inhibitor. Therefore, when the water content of the intake air is taken into account, the risk of knocking in the combustion chamber and therefore the respective requirement to feed water can be determined with greater accuracy.

In one embodiment of the method for increasing the possible compression ratio of internal combustion engines of motor vehicles in the case of the varying fuel quality, during the feeding of the fuel the water is introduced, in particular injected, directly into the combustion chamber or into an air supply pipe of the internal combustion engine.

As already stated, feeding water to the fuel, in particular into the combustion chamber or into the air supply pipe, causes the mixture temperature to drop owing to evaporation cooling, and the water or the water vapor additionally acts in a gas a result of dilution effects. These effects are utilized when the water is injected into an air supply pipe of the internal combustion engine and is conducted with the intake air into a combustion chamber of the internal combustion engine. In the case of direct injection of water into the combustion chamber, which is alternatively also possible, the cooling efficiency of the cooling of the mixture can be increased further since heat transfer losses at the walls, i.e. of the air supply pipe are avoided and the fuel in the combustion chamber evaporates more quickly and more completely owing to the increase in the compression temperature in the compression stroke of the engine, and at the same time the mixture of temperature drops directly.

In another embodiment of the method for increasing the possible compression ratio of internal combustion engines of motor vehicles in the case of varying fuel quality method the water is mixed with the fuel and introduced, in particular injected, as an emulsion directly into the combustion chamber or into an air supply pipe of the internal combustion engine. In this variant, the possibility of uniformly mixing the water with the fuel before the emulsion produced here mixes with the combustion air is advantageous. In this context, the preparation of the mixture and evaporation cooling are particularly efficient, so that the water requirement can then turn out to be lower overall.

The method for increasing the possible compression ratio of internal combustion engines of motor vehicles in the case of varying fuel quality can be used advantageously in alcohol flex fuel engines. The short-chain alcohols, such as methanol or ethanol, which are used in such engines are very knock-resistant fuels which have very high knock resistance compared with mineral-oil-based gasolines. Using one or more options of the method described above, the internal combustion engine can be configured with a compression ratio which is relatively large compared to alcohol flex fuel engines of a known design, since when a fuel which is less knock resistant burns, the knock resistance of this fuel can be correspondingly increased by feeding water.

When the proposed method is used, the more water which is introduced into the fuel, the lower the alcohol content of basic fuel and the less knock resistant the fuel is. As a result, the compression ratio of the engine and therefore its thermal efficiency can be increased overall, as a result of which improved consumption values are also obtained.

In order to achieve the object, a device is also provided for increasing the possible compression ratio of internal combustion engines of motor vehicles in the case of varying fuel quality. The device has at least one apparatus for determining the knock resistance of the fuel, at least one apparatus for sensing the operating state of the internal combustion engine, one water tank and one feed apparatus for feeding water to the fuel. The device also has an apparatus for determining a requirement for feeding water to the fuel in accordance with the determined knock resistance of the fuel and the operating state of the internal combustion engine, and a feed apparatus for feeding water to the fuel, in particular into the internal combustion engine or into the air supply pipe according to the determined requirement.

With the proposed device it is possible to implement one or more options of the method described above. As already stated, the feeding of water to the fuel according to the respectively determined requirement serves to increase the knock resistance of the fuel and therefore to provide improved protection against knocking. Feeding water to the fuel permits the compression ratio and therefore the thermal efficiency of the engine to be increased, as a result of which a significant improvement in the fuel consumption can be achieved at moderate cost and with moderate deployment of materials.

Apparatuses and relationships which have already been described in relation to the method are also to be understood in a corresponding way in relation to the proposed device, so that explanations which have been given with respect to the method will not be repeated once more with respect to the device at this point.

Possible embodiments of an apparatus for determining the knock resistance of the fuel have already been described in relation to the method. An apparatus for sensing the operating state of the internal combustion engine can be, for example, part of the engine controller or at least connected thereto, since the operating state is sensed and further processed by the engine controller or by apparatuses connected thereto, such as sensors etc. The information that is necessary for the compression and which relates to the operating state of the internal combustion engine is therefore usually available in the engine controller.

Possible embodiments of an apparatus for determining the knock resistance of the fuel, the water tank or possible feed apparatuses for feeding water to the fuel have already been described in relation to the method.

The device also has an apparatus which determines, in accordance with the determined knock resistance of the fuel and the data received from the apparatus for sensing the operating state of the internal combustion engine, the requirement to feed water to the fuel. On the basis of the respective determined requirement, the feed apparatus feeds the corresponding water to the fuel. Possible embodiments of a feed apparatus which introduces, in particular, the quantity of water and the feed time and the feed time period or the volume flow rate of water in to the fuel have already been described in relation to the proposed method.

In one embodiment of the device for increasing the possible compression ratio of internal combustion engines of motor vehicles in the case of varying fuel quality, the feed apparatus for feeding water to the fuel is configured to form an emulsion of fuel and the determined requirement of water. Such an apparatus is connected both to the fuel tank and to the water tank and has suitable apparatuses for forming an emulsion of water and fuel. In addition, the feed apparatus is embodied in such a way that it can used to introduce the emulsion in a suitable way directly into the combustion chamber or into the air supply pipe where it mixes with the air fed to the internal combustion engine.

In another embodiment of the device for increasing the compression capability of a fuel, the feed apparatus for feeding the water has an injection nozzle which is arranged in the combustion chamber or in the air supply pipe. The injection nozzles or the feed apparatuses for the water are embodied in different ways in these cases, since, owing to the high pressures which prevail in the combustion chamber the water also has to be injected at high pressure into the said combustion chamber in order to achieve suitable distribution of the water in the fuel/air mixture. An injection of water into the air supply pipe occurs at a correspondingly lower pressure, for which reason the injection nozzle for suitably feeding the water is designed in a different way here.

In one embodiment of the device for increasing the possible compression ratio of internal combustion engines of motor vehicles in the case of varying fuel quality, the internal combustion engine is an alcohol flex fuel engine. Since there are large differences in the knock resistance of the fuels used in flex fuel engines and these engines are usually configured with the lowest knock resistance with respect to a fuel which can be used, the compression ratio and the thermal efficiency can be greatly increased in alcohol flex fuel engines.

In a further aspect of the invention, a control apparatus is provided for a motor vehicle for carrying out the method for increasing the possible compression ratio of internal combustion engines of motor vehicles in the case of varying fuel quality and for operating a device for doing so. The control apparatus here is configured to:

read in data which permit the knock resistance of the fuel to be determined,

read in data which characterize the operating state of the internal combustion engine,

evaluate the read-in data in order to determine a requirement to feed water to the fuel in accordance with the determined knock resistance of the fuel and the determined operating state of the internal combustion engine, and

control the feeding of water to the fuel according to the determined requirement.

Apparatuses and relationships which have already been described in relation to the method and the device are to be also correspondingly understood in relation to the proposed control apparatus. The control apparatus is connected, in particular, to the apparatuses for determining the knock resistance of the fuel, for sensing the operating state of the internal combustion engine, for determining the requirement to feed water to the fuel and to the feed apparatus for feeding water to the fuel and is suitable for controlling the proposed method and for the use within the scope of the proposed device and consequently also for achieving the advantages associated therewith.

Other objects, advantages and novel features of the present invention will become apparent from the following detailed description of one or more preferred embodiments when considered in conjunction with the accompanying drawings.

### BRIEF DESCRIPTION OF THE DRAWINGS

FIG. 1 is a schematic illustration of an exemplary device according to the invention for increasing the possible compression ratio of internal combustion engines of motor vehicles in the case of varying fuel quality in an internal combustion engine.

FIG. 2 is a schematic illustration of a further exemplary device according to the invention, wherein the water is fed directly into the combustion chamber.

FIG. 3 is a schematic illustration of a further exemplary device according to the invention, wherein an emulsion of water and fuel is fed to the combustion chamber.

### DETAILED DESCRIPTION OF THE DRAWINGS

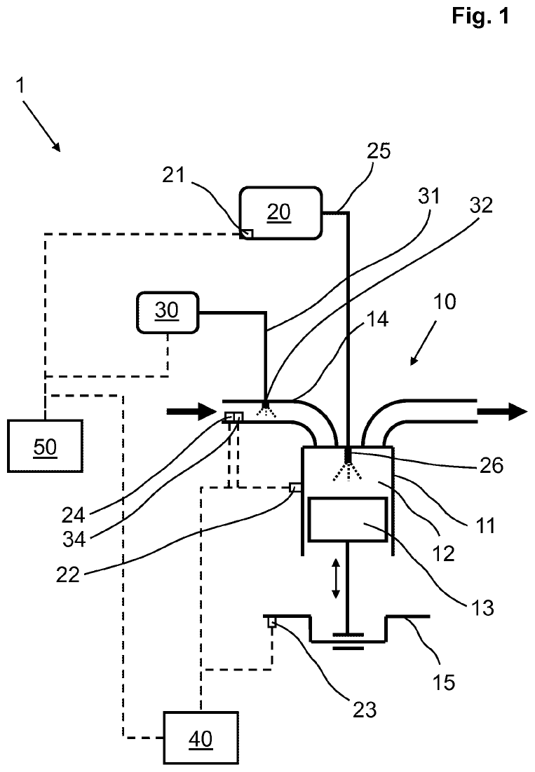

FIG. 1 shows an exemplary device 1 for increasing the possible compression ratio of internal combustion engines of motor vehicles in the case of varying fuel quality in an internal combustion engine 10 of a motor vehicle. FIG. 1 illustrates a cylinder 11, illustrated by way of example, of the internal combustion engine 10 with a piston 13 which can move up and down in the combustion chamber 12, in order to burn the fuel. The device 1 has a fuel tank 20 with a fuel sensor 21, and a knock sensor 22 which is arranged on the cylinder 11 and has the purpose of determining the knock resistance of the fuel. The internal combustion engine 10 can be, for example, an alcohol flex fuel engine, and in such an embodiment the fuel tank 20 contains a mixture of gasoline and alcohol fuel.

In addition, the device 1 has a rotation speed sensor 23 on the crankshaft 15 of the internal combustion engine 10, connected to the computing device 40, which rotation speed sensor 23 has the purpose of sensing the operating state of the internal combustion engine 10. A temperature sensor 24 and a water content sensor for sensing the temperature and the water content of the air which is conducted into the combustion chamber 12 are also arranged on the air supply pipe 14 of the exemplary embodiment. Connections for transferring measurement signals or control signals are illustrated in the form of dashed lines.

In addition, provided on the device 1 are a water tank 30 and a water line 31 as a feed device for feeding water to the fuel, and an injection nozzle 32 for injecting water into the air feed line 14. Provided on the internal combustion engine 10 are a fuel tank 20, a fuel line 25 and an injection nozzle 26 as a feed device for the fuel, which injection nozzle 26 has the purpose of injecting fuel into the combustion chamber 12. The device 1 also has an apparatus 50 for determining a requirement to feed water to the fuel in accordance with the determined knock resistance of the fuel and the operating state of the internal combustion engine 10.

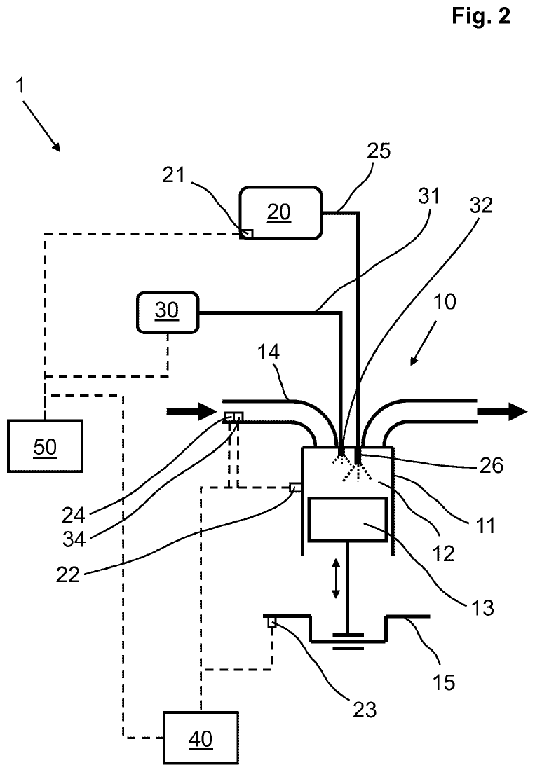

FIG. 2 shows an further exemplary device 1 for increasing the possible compression ratio of internal combustion engines 10 of motor vehicles in the case of varying fuel quantity of a motor vehicle. FIG. 2 differs from FIG. 1 in that the injection nozzle 32 for the water is arranged on the wall of the combustion chamber, so that the water is fed to the fuel directly in the combustion chamber.

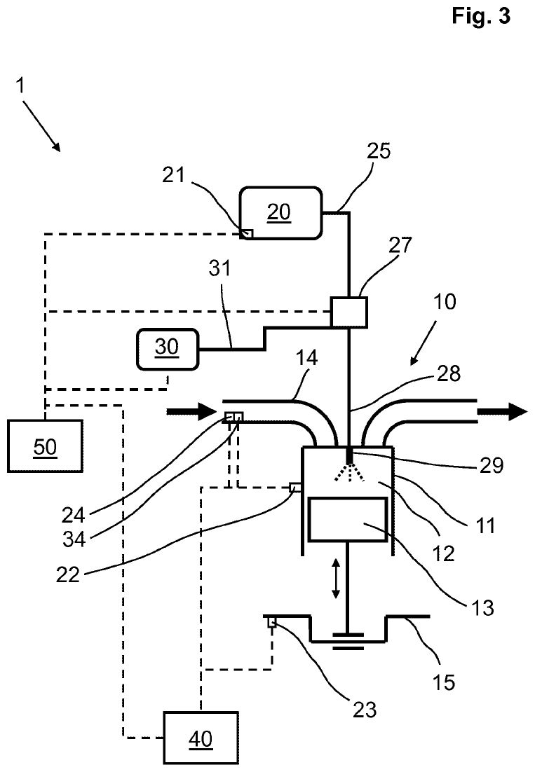

FIG. 3 shows an further exemplary device 1 for increasing the possible compression ratio of internal combustion engines 10 of motor vehicles in the case of varying fuel quality of a motor vehicle.

FIG. 3 differs from FIG. 2 in that it has a mixing apparatus 27 for adding water to the fuel, which mixing apparatus 27 is suitable for forming an emulsion of fuel and water. The mixing apparatus 27 forms part of the feed apparatus for the water and is connected to the fuel tank 20 via the fuel line 25 and to the water tank 30 via the water line 31 and is configured to form an emulsion of water and fuel. In addition, the mixing apparatus 27 is connected via an emulsion line 28 to the injection nozzle 29 which serves to inject the emulsion into the combustion chamber 12 of the internal combustion engine 10.

### LIST OF REFERENCE NUMBERS

1 Device for increasing the compression capability of a fuel
10 Internal combustion engine
11 Cylinder
12 Combustion chamber
13 Piston
14 Air feed line
15 Crankshaft
20 Fuel tank
21 Fuel sensor
22 Knock sensor
23 Rotational speed sensor
24 Temperature sensor
25 Fuel line
26 Injection nozzle
27 Mixing apparatus
28 Emulsion line
29 Injection nozzle
30 Water tank
31 Water line
32 Injection nozzle
34 Water content sensor
40 Computing apparatus
50 Apparatus for determining a requirement to feed water to the fuel

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A method for increasing a possible compression ratio of an internal combustion engine for a motor vehicle in a case of varying fuel quality in the internal combustion engine having a combustion chamber for burning fuel, the method comprising the steps of:
determining a knock resistance of the fuel and/or the fuel quality;
sensing an operating state of the internal combustion engine;
determining a requirement to feed water to the fuel in accordance with the determined knock resistance and/or quality fuel and the operating state of the internal combustion engine; and
feeding water to the fuel according to the determined requirement.

2. The method according to claim 1, wherein
the knock resistance of the fuel is determined by a sensor which is arranged at a fuel supply system.

3. The method according to claim 1, wherein
the determination of the knock resistance of the fuel is carried out in a software-based fashion using operating values of the internal combustion engine which are determined at the internal combustion engine.

4. The method according to claim 1, further comprising the step of:
sensing a temperature of intake air and taking into account said temperature during the determination of the requirement to feed water the fuel.

5. The method according to claim 4, further comprising the step of:
sensing a water content of intake air and taking into account said water content during the determination of the requirement to feed water to the fuel.

6. The method according to claim 1, further comprising the step of:
sensing a water content of intake air and taking into account said water content during the determination of the requirement to feed water to the fuel.

7. The method according to claim 1, wherein
during feeding of the fuel, the water is introduced directly into the combustion chamber or into an air supply pipe of the internal combustion engine.

8. The method according to claim 1, wherein
the water is mixed with the fuel and is introduced as an emulsion directly into the combustion chamber or into an air supply pipe of the internal combustion engine.

9. The method according to claim 1, wherein the method is used to increase the possible compression ratio of the internal combustion engine in the case of varying fuel quality for an alcohol flex fuel internal combustion engine.

10. A device for increasing a possible compression ratio of an internal combustion engine of a motor vehicle in a case of varying fuel quality, the internal combustion engine having a combustion chamber for burning a fuel, the device comprising:
a knock resistance determining device that determines a knock resistance of the fuel;
an operating state sensing device that senses an operating state of the internal combustion engine;
a water tank and an associated feed apparatus that feeds water from the water tank to the fuel; and
a water feed requirement determining device that determines a requirement to feed water to the fuel in accordance with the determined knock resistance of the fuel and the sensed operating state of the internal combustion engine, wherein
the feed apparatus feeds water to the fuel based on the determined requirement.

11. The device according to claim 10, wherein
the feed apparatus is configured to form an emulsion of fuel and water according to the determined requirement.

12. The device according to claim 10, wherein
the feed apparatus for the water has an injection nozzle arranged in the combustion chamber or in an air supply pipe.

13. The device according to claim 10, wherein
the internal combustion engine is an alcohol flex fuel engine.

14. A control apparatus of a motor vehicle that controls an increase of a possible compression ratio of an internal combustion engine in a case of varying fuel quality in the internal combustion engine, wherein
the control apparatus is operatively configured to:
read in data which permit a knock resistance of the fuel to be determined;
read in data which characterize an operating state of the internal combustion engine;
evaluate the read-in data in order to determine a requirement to feed water to the fuel in accordance with the determined knock resistance of the fuel and the determined operating state of the internal combustion engine; and
control metering and feeding of water to the fuel based on the determined requirement to feed the water to the fuel.
